(19) United States
(12) Patent Application Publication
(10) Pub. No.: US 2004/0135369 A1
(43) Pub. Date: Jul. 15, 2004

(54) Corrugated pipe connecting arrangement and corrugated pipe

(76) Inventor: Soren Schroter, Bamberg (DE)

Correspondence Address: LAW OFFICES OF RAYMOND A. NUZZO, LLC, 579 THOMPSON AVENUE, EAST HAVEN, CT, 06512, US

(21) Appl. No.: 10/724,967

(22) Filed: Dec. 1, 2003

(30) Foreign Application Priority Data
Dec. 3, 2002 (DE) 202 18 734.9

(51) Int. Cl. F16L 37/00

(52) U.S. Cl. 285/305; 285/903

(57) ABSTRACT

The present invention relates to a corrugated pipe connecting arrangement comprising a corrugated pipe with corrugations extended transverse to its longitudinal axis, which can be arranged at substantially identical distances from each other, wherein said corrugated pipe is formed with a one-piece plain region at at least one end, said plain region comprising an abutment section, and can engage with a connecting element which may be merged with said plain region and said abutment section.

### BACKGROUND OF THE INVENTION

1. Technical Field

The invention relates to corrugated pipes and corrugated pipe connecting arrangements. The corrugated pipe connecting arrangement comprises a corrugated pipe with corrugations extended transverse to its longitudinal axis, which can be arranged at substantially identical distances from each other, said corrugated pipe comprising at least one end region. The invention further relates to a plastic corrugated pipe connecting arrangement.

2. Description of the Related Art

Many and various areas of use for corrugated pipes are known in the prior art. Corrugated pipes are now used as jet water conduits, for transporting jet water from a storage tank within a motor vehicle to an outlet nozzle. Such an application requires a connection which is highly resistant, even at higher pressures, and does not develop leaks at high pressure. To this end, connecting elements are often coiled onto corrugated or plain pipes and permanently connected to each other by radially pressing. The connecting elements must be made of a particular plastic, in order for instance to be fuel-resistant and to prevent the plastic from creeping, which can occur under mechanical stress and when permanently stressed could lead to leaks.

It is otherwise also necessary to connect corrugated pipes to each other in other specialist fields, be it without pressure or in applications in which pressures above atmospheric pressure occur. In any event, a number of connecting elements, fixing elements and the like are required.

In accordance with the prior art, it is consequently necessary to insert connecting elements into corrugated pipes in order to then be able to connect the corrugated pipe ends prepared in this way to standard commercial connectors.

A connecting arrangement known from the prior art, for extending a hose or conduit, is shown in FIG. 6. An extension adapter 204, 202, 206 is provided, such that a hose or a pipe 212 with a connecting socket 205 can be plugged onto both ends of the adapter. It is necessary here, in a very costly process, to provide the hose or corrugated pipe 212 with the socket 205 by injecting the socket 205 on in a connecting region 210. The socket is then slid onto the support sleeve 204 of the extension adapter, where a serrated tooth-like engagement and sealing structure is provided which is formed from connected serrated tooth profiles. The connection is mechanically fixed by a metal sleeve 208, wherein the metal sleeve 208 is to be pressed in order to expand the material of the socket 205 into the profiling of the serrated tooth structure by deforming the sleeve 208.

It is clear that such a connecting arrangement is not only very costly but gives rise to sealing problems.

### SUMMARY OF THE INVENTION

Consequently, it is an object in accordance with the present invention to provide a new connecting technique in order to be able to connect corrugated pipes, wherein such a connecting technique is intended in particular for applications with low pressure or without pressure.

In particular, the intention is to provide a new way of connecting, for evacuating tanks, batteries or the like.

Furthermore, the intention is to provide a new connecting technology, using which it is possible to get by with less labor and material cost.

An application with low pressure is to be understood as an application with a pressure in the range of 0.1 to 0.7 bars, in particular 0.3 to 0.5 bars. An application without pressure is to be understood as an application with near to atmospheric pressure.

In accordance with the invention, this is achieved by fitting the corrugated pipe with a one-piece plain region at least one end, said plain region comprising an abutment section. A connecting element such as may be used in accordance with the invention can be merged with the plain region, and the abutment section on the plain region of the corrugated pipe can be engaged with the connecting element.

Corrugated pipes of the type in accordance with the invention are manufactured continuously by means of a corrugator which can be embodied in the known excess pressure or partial vacuum variants. In the case of the excess pressure variant, a stamp is inserted into a thermoplastically deformable plastic hose, and an excess pressure is established in a region between an outlet nozzle of an extruder and within the molding channel of a corrugator, said excess pressure forcing the thermoplastically deformable plastic material into the half-moulds of the corrugator which form a closed molding channel. In the case of a partial vacuum variant of a corrugator, a partial vacuum is established between the thermoplastically deformable wall of the plastic hose and the half-moulds merged into the molding channel, which draws the plastic material into the profile in order to impress said profile onto the plastic hose. In each case, the molded plastic hose is cooled, such that the pipe and then the corrugated pipe is transferred to a non-deformable state.

In the run of such a corrugated pipe, plain regions and/or abutment sections are impressed in the pre-set mould in accordance with the invention. Such a pipe can then be cut at the desired locations in order to be able to manufacture individual corrugated pipe sections with the characteristics in accordance with the invention.

With respect to the connecting element in accordance with the invention, it may be stated that said connecting element can in principle be formed according to the prior art or formed from it. The essential features in accordance with the invention are to be seen in the plain region provided as one piece, which enables a corrugated pipe connecting arrangement which is predestined for a low-pressure area of use and is efficient, cost-effective and future-orientated.

The abutment section is advantageously formed at least over a partial circumference, preferably over a full circumference. Forming it over a partial circumference, which can save on material, is sufficient in order to be able to form a secure engagement. In order to be able to guarantee a certain mechanical stability, it is preferable to provide an abutment section on the plain region which is provided radially outwards over a full circumference.

The abutment section can then be formed in particular as a radially protruding rib, as a ring or the like. Such a shape is easily manufactured in the corrugator and guarantees permanent stability.

Advantageously, a connecting section is provided between the abutment section and the corrugations and can be formed such that standard commercial connectors can be used. This connecting section can be specially adapted to the connectors being used or can be adapted to a broad range of connectors, such that maximum connectors dimensions are taken into account.

The connecting section is preferably formed even, i.e. it also forms a plain region formed without corrugations.

The connecting element to be used in accordance with the invention preferably comprises at least one sealing means which can abut the plain region, forming a seal. An O-ring, molded out in the inner circumference of the corrugated pipe connecting region—formed as a collar or ring—of the connecting element or connector, is for instance recommendable as a sealing means.

The connecting element advantageously comprises an abutting means which can be inserted into the accommodating space for the plain region, surrounding it. The sealing element can then be accommodated between the abutting means and a collar region. If the O-ring is built into the connecting element, it can be fixed in the axial direction in the connecting element via the abutting means, such that on the one hand the O-ring can no longer fall out of the connecting element, but on the other hand can abut the plain region of the corrugated pipe in accordance with the invention, forming a seal.

Advantageously, the abutting means can be fixed within the connecting element by comprising a radial extension which is extended outwards and can engage with a latching recess on the inner circumference of the connecting element, in order to be able to form an arrangement which may be assembled.

The connecting element is advantageously provided with a closure element which is extended radially inwards and can reversibly abut against the abutment section of the corrugated pipe, via at least one recess in the connecting element. The closure element can for instance be formed as a fork-like blocking member or the like. It can also be formed as a latching element which is fixed on the connecting element via a film hinge or the like and can be pivoted into a closure position. The person skilled in the art knows various ways to achieve this from the prior art, which consequently do not need to be described further here.

In accordance with another aspect of the present invention, a corrugated pipe connecting arrangement comprising a corrugated pipe with corrugations extended transverse to its longitudinal axis is proposed, wherein the corrugated pipe is provided on at least one of its end regions with a connecting region which is formed integrally with the corrugated pipe and can be inserted in a socket connecting section, said connecting region being provided, for connecting to the socket connecting section, with at least one, preferably a number of serrated tooth-like profiles which run in the insertion direction and can abut the inner circumference of the socket connecting section. If for instance the socket is preferably made of the plastic material TPE, the plastic material of the corrugated pipe can engage with the socket material by compressing the socket material. It is of course advantageous if various serrated tooth-like profiles are provided.

The inner circumference of the socket connecting section is preferably plain-walled, at least in regions, over a full circumference, in order that the position of the serrated tooth-like profiles necessary at the end of an assembling situation does not have to be maintained precisely, in order to achieve the desired sealing effects.

In order to facilitate inserting the end region of the corrugated pipe, it is advantageous if the serrated tooth-like profile has an ascending flank in the insertion direction which is at an acute angle with respect to the insertion direction, such that no significant resistance can arise when inserting the end region.

Conversely, it is advantageous, in order to be able to apply significant holding forces, if the serrated tooth-like profile exhibits a steeply descending or steeply ascending flank on the rear side of the ascending flank, said steeply descending or steeply ascending flank applying a significant resistance counter to the insertion direction if an attempt is made to wrench the corrugated pipe or its end region out of the socket connecting section.

In accordance with another aspect of the present invention, a corrugated pipe is provided which comprises at least one corrugated pipe section and is provided with a connecting region at at least one end region, wherein said connecting region comprises at least one, preferably a number of serrated tooth-like profiles and is formed integrally with the corrugated pipe or its corrugated pipe section. Generally, it may be stated that a corrugated pipe in accordance with the invention can also comprise individual plain-walled sections, in particular in order to bridge regions, in which the pipe does not have to be deformed, like a conduit.

Another aspect of the present invention relates to a plastic corrugated pipe connecting arrangement comprising a plastic corrugated pipe section with corrugations extended transverse to its axial longitudinal axis is proposed, comprising an integrally formed support section at at least one end, wherein the support section comprises a first diameter region and at least one sealing and/or holding element can be inserted into the first diameter region. The latter can preferably be held in position by a connector means. Such a plastic corrugated pipe connecting arrangement can be manufactured as one piece or integrally with respect to its main components, i.e. the corrugated pipe section and the support section, using a corrugation process. As is known, a corrugated pipe with its molded-in structures is manufactured continuously as one piece in such a corrugation process. In the present case, a thermoplastically deformable plastic hose is outputted from an extruder nozzle and inserted into the molding path of a corrugator. There, the corrugated pipe in accordance with the invention or the plastic corrugated pipe connecting arrangement in accordance with the invention is structured in a molding channel formed by half-moulds. Some of the closed half-moulds exhibit the corrugations and others exhibit the shape of the support section. If such a continuously manufactured plastic corrugated pipe or plastic corrugated pipe connecting arrangement is cut off at the respective locations, individual plastic corrugated pipe sections comprising plastic corrugated pipe connecting arrangements in accordance with the invention result.

If a plain region in accordance with the initially described aspect of the invention is then inserted into a support section in accordance with the subsequently described aspect, said plain region presses the at least one sealing and/or holding element radially outwards and on the one hand seals and on the other additionally mechanically fixes the connection.

For additional fixing, the sealing and/or holding elements can also be pressed in the axial direction of the corrugated pipe or the support section. Rubber O-rings or the like can for instance be used as sealing and/or holding elements. Said axial pressing can provide an additional holding force and possibly an additional seal, even at significant pressures.

The invention advantageously also relates to a plastic corrugated pipe connecting arrangement in which the sealing and/or holding element is formed from a part, manufactured as one piece, which comprises a holding function region and at least one sealing function region, i.e. the holding function region enables the sealing and/or holding element to be held in its correct position within the connecting arrangement and the at least one sealing function region abuts a plain region on the corrugated pipe to be connected on the one hand and the plain region within the integrally formed support section on the other, so as to be able to provide a connection which can be mechanically held and sealed. In order to be able to hold the holding function section within the integrally formed support section, and preferably within the first diameter region of the support section, an engagement function region assigned to the holding function section of the part manufactured as one piece can be provided on the inner circumference of the components cited, said engagement function region holding the part manufactured as one piece or the sealing and/or holding element in the axial direction. In this way, this aspect in accordance with the invention can be pre-assembled ready for use, and there exists no danger of individual components being lost during transport or assembly. Furthermore, assembly is simplified, since fewer individual parts are provided and the arrangement as a whole is more stable.

The part manufactured as one piece is particularly advantageous if it comprises two sealing function regions which are arranged symmetrically or asymmetrically with respect to the holding function region in the axial direction of the arrangement. The holding function section itself can then additionally comprise a sealing area provided on the inner circumference.

If a number of sealing and/or holding elements are used, for instance in the form of O-rings, it is advantageous to insert distancing rings between them which are not deformable, such that the O-rings cannot yield axially into the free spaces left free by adjacent O-rings, which could compromise the sealing and/or holding function. Another additional sealing and/or holding function can then be achieved by additionally arranging other sealing and/or holding elements with distancing rings lying in between. A locking section is advantageously provided on the outer and/or inner circumference of the support section. Accordingly, a correspondence section on the connector means is capable of entering a locking position with the locking section, in order to hold the sealing and/or holding elements and possibly also the plain region of the connected corrugated pipe in its functional position, irrespective of the prevalent pressure or other mechanical stresses. The locking section in conjunction with the correspondence section can thus be a latching connection, a screw connection or other conventional connection such as for instance a bayonet connection or the like.

When two corrugated pipes are to be connected to each other, it is particularly advantageous if one corrugated pipe comprises a connecting section in accordance with the first aspect of the invention at one end, while the other corrugated pipe comprises a plastic corrugated pipe connecting arrangement in accordance with the second aspect of the invention at at least one end.

### BRIEF DESCRIPTION OF THE DRAWINGS

The present invention will now be explained in more detail by way of the enclosed figures and by referring to the description of the figures. This shall disclose further aims, features and advantages of the invention, which could be made the subject of claims. There is shown:

FIG. 1 an embodiment of a corrugated pipe having features in accordance with the invention, in a side view;

FIG. 2 an end region of a corrugated pipe in accordance with the invention, in an axial longitudinal section;

FIG. 3 a section through a connecting element or connector such as may be used in accordance with the invention;

FIG. 4 a corrugated pipe formed in accordance with FIGS. 1 and 2, inserted into a connector in accordance with FIG. 3, wherein the connector is shown in section, while the corrugated pipe is shown in a side view; and

FIG. 5 in a partial section, a corrugated pipe connecting arrangement in accordance with another aspect according to the present invention, and a corrugated pipe arrangement in accordance with another aspect according to the present invention;

FIG. 6 in a partial cut-away, a corrugated pipe connecting arrangement in accordance with the prior art; and

FIG. 7 a corrugated pipe comprising an integrally formed connecting support, in a longitudinal section;

FIG. 8 a corrugated pipe comprising a connecting support in accordance with FIG. 7 and a corresponding connector means, each in a longitudinal section, and a lateral view of a plain region of a connected corrugated pipe, for instance in accordance with FIGS. 1 and 2, before a connection is established;

FIG. 9 a longitudinal section through an established connection to the components in accordance with FIG. 8;

FIG. 10 another embodiment having features in accordance with the invention, in a partial longitudinal section; and

FIG. 11 another embodiment having features in accordance with the invention, in another partial longitudinal section.

### DETAILED DESCRIPTION

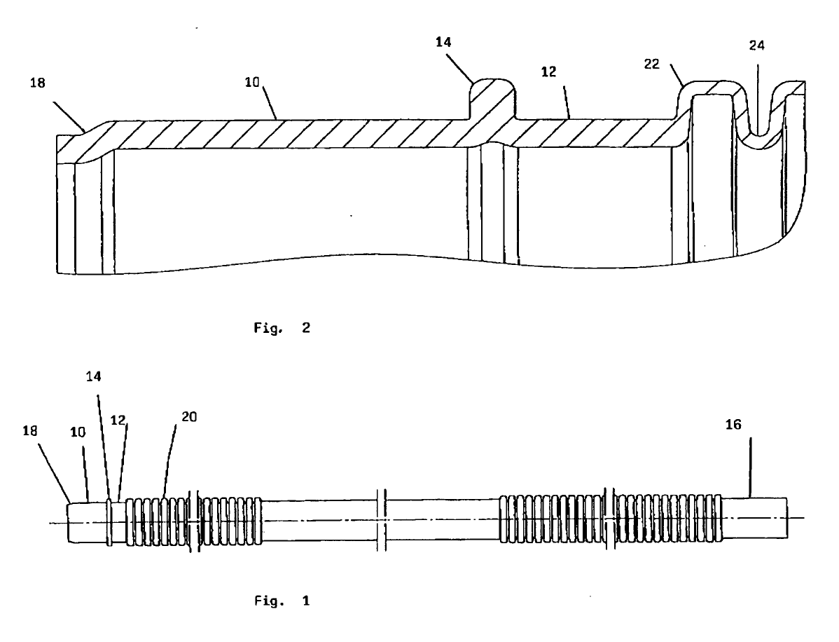

Identical or at least functionally identical means shown in FIGS. 1 to 4 are cited using the same reference numerals, such that it is not necessary to repeatedly mention the same components.

FIG. 1 shows a corrugated pipe comprising a corrugated pipe region 20 and end regions 16. The corrugated pipe region 20 in accordance with FIGS. 1, 2 and 4 comprises corrugation peaks 22 and corrugation valleys 24.

In accordance with the invention, a plain region 10, 12 is provided which is formed as one piece integrally with the corrugated pipe region 20. As may be gathered in particular from FIG. 2, the plain region comprising the abutment section, which may be referred to as a formed adapter, is formed with a thicker wall than the adjacent corrugated pipe region comprising the corrugation peaks 22 and corrugation valleys 24. This guarantees high stability in the region of the plain region 10, 12 or adapter 10, 12 provided as one piece.

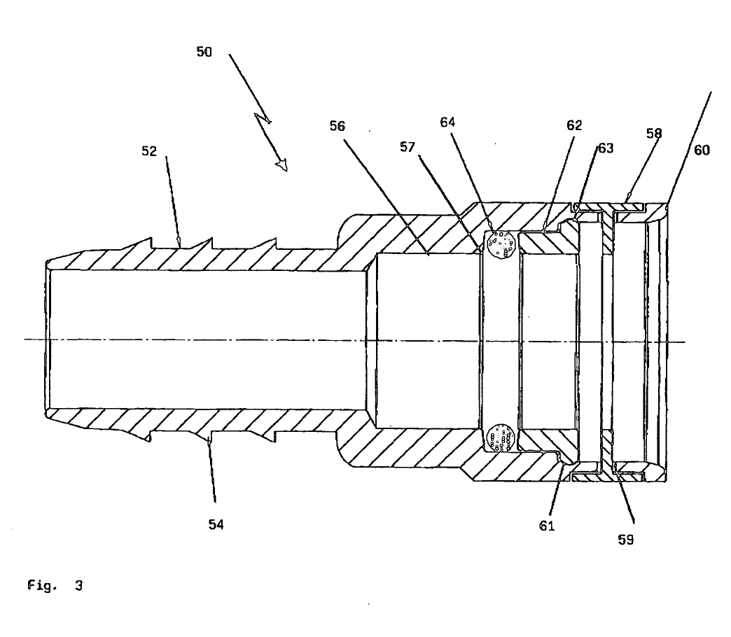

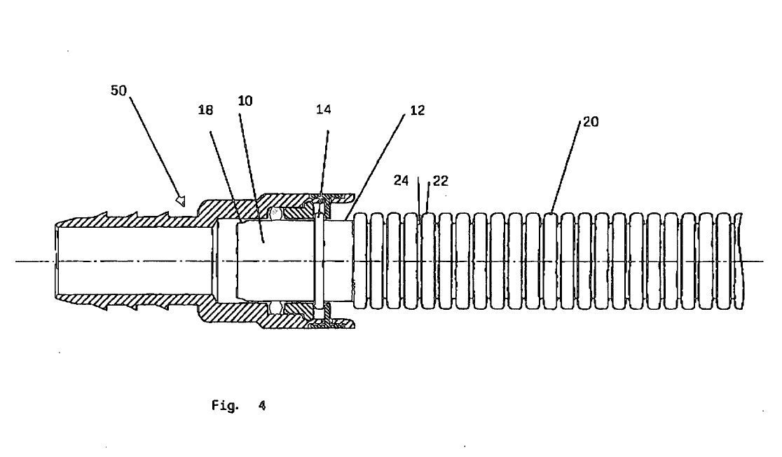

On its outer circumference, the plain region 10 provides a plain surface which can contact a sealing element or O-ring 64 (see FIG. 3), in order to be able to connect the plain region 10 and the corrugated pipe in accordance with the invention, forming a seal, in particular to a connector or connecting element 50 in accordance with FIGS. 3 and 4.

The corrugated pipe in accordance with the invention comprises an abutment section on its plain region 10, 12, which can be provided on at least one side or one end of the corrugated pipe, wherein a holding engagement can be established with a connecting element or connector 50 via said abutment section.

In order to simplify inserting the corrugated pipe adapter region 10, 14, 12 into a connector or connecting element 50, the adapter 10, 12, 14 can be provided with a securely tapering section 18 on its end assigned to the connecting element 50, in order to be able to more easily insert the adapter into the opening region of the connecting element or connector 50.

The abutment section 14 is formed as an annular collection of material, extended radially outwards from the central axis of the pipe. As already indicated, the pipe in accordance with the invention is manufactured from plastic and molded in accordance with a corrugator. The abutment section 14 is rendered as a continuous, annular extension going radially outwards, but can also merely be provided in the form of section over a partial circumference.

The connecting element 50 in accordance with FIG. 3 comprises an attaching region 52 comprising latching extensions 54, in order for example to be able to engage with a tank opening. A socket region connects to the attaching region 52, which comprises a cylindrical hollow space in order to be able to accommodate an end region of a corrugated pipe in accordance with the invention. The plain region 10 of the corrugated pipe in accordance with the invention thus comes to rest within the cylindrical hollow space 56 and a part of the plain region 10 comes to rest opposite a sealing means or O-ring 64, in order to be able to provide a sufficient sealing effect, at least in the low-pressure range or for applications without pressure. The O-ring seal 64 is fixed in the axial direction between a collar section 54 on the inner circumference of the socket section and an abutting means 62. The abutting means 62 is formed with an engagement or latching extension 63 which can enter into latching engagement with a recess 61 on the inner circumference of the socket-like section of the connecting element or connector 50.

A closure element 58 can engage radially inwards with the connector 50 via one or more recesses 59 on the socket, in order to fix the abutment section 14 of the pipe formed in accordance with the invention between the abutting means 62 and the closure element 58, such that the pipe is fixed in the axial direction and can no longer be removed from the connecting element or connector 50. An opening section 60, formed slightly funneled, of the connecting element or connector 50, in conjunction with the tapering end section 18 on the connector end of the plain region 10, ensures that inserting is simplified and that sharp edges are removed.

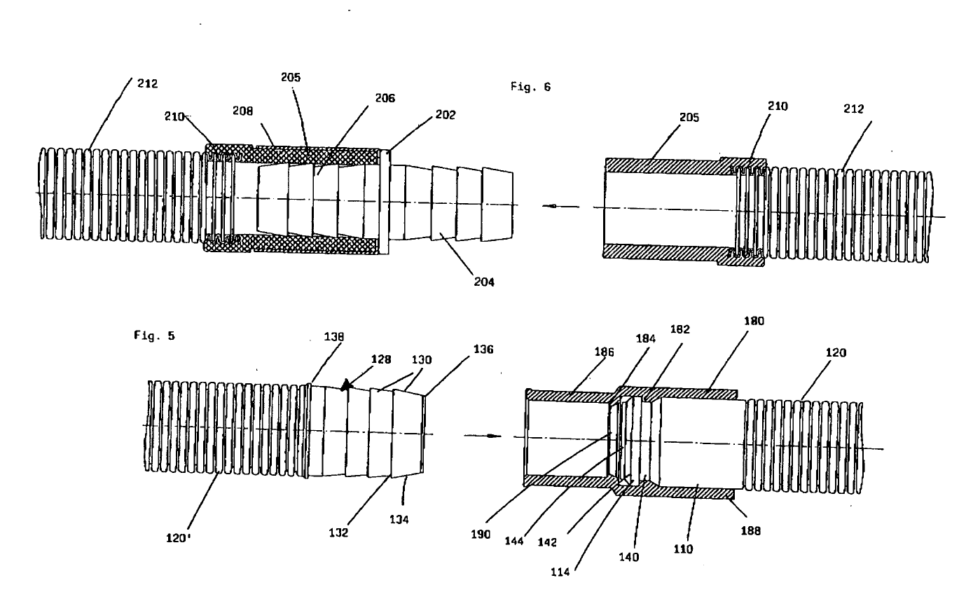

FIG. 5 shows another embodiment in accordance with the invention. On the one hand, a corrugated pipe comprising a connecting region 128 in accordance with one aspect of the invention is shown here, and on the other a corrugated pipe connecting arrangement 180 comprising an already connected corrugated pipe in accordance with another aspect according to the present invention is shown.

The corrugated pipe 120′ comprising the connecting region 128 comprises an opening 136 which when installed comes to rest in the connecting section 186 of the socket 180 opposite the opening 144 of the connecting section 110 of the corrugated pipe 120.

The connecting region 128 exhibits a serrated tooth-like profiling 130, wherein each of the serrated teeth comprises a flank 134 which ascends into the socket 180 in the insertion direction and ascends at a relatively small angle, such that no significant resistance can occur when the connecting section 128 is inserted. On the rear side of the flank 134, a very steeply descending flank 132 is provided which offers a significant resistance when the corrugated pipe 120′ or its connecting region 128 is pulled or wrenched out of the section 186 of the socket 180. By forming the serrated teeth 130 as shown, in conjunction with the expansion properties of the material of the socket 180, significant holding forces can be applied. This can be further increased by additionally laying a pressing ring around the section 186 of the socket 180, which can be pressed once the connecting region 128 has been inserted into the section 186.

The connecting region 128 comprises a stopper 138 on its end facing away from the opening 136, said stopper abutting against the facing side of the section 186 of the socket 180, in order to limit the insertion movement such that the connecting region 128 in each case enters a defined position in the section 186 of the socket 180. The projection 184, which is extended radially inwards and can be provided circumferentially over the entire inner circumference of the socket 180, can deploy a certain sealing effect, and the transition region between the collar 184, extended radially inwards, and the connecting region 110 of the pipe 120 can serve to adapt the conduit, for example in order to reduce flow noise or the like. A transition region 190 provided for this purpose is not, however, essential with regard to the present invention.

The connecting region 110 of the corrugated pipe 120 comprises a plain-walled section which directs relates to reference numeral 110. Adjacent to the plain-walled region is a constriction 140, followed by a rib-like abutment section 114. The structure of the constriction 140, in conjunction with the rib-like abutment 114 enters into holding engagement with a latching collar 182, aligned radially inwards, of the socket 180. An obliquely running region 142 is provided in front of the abutment 114 in the insertion direction for the connecting section 110 of the corrugated pipe 120, said region 142 serving as an insertion aid and for deflecting the latching collar 182 during the assembling process of the connecting region 110 within the socket 180.

The material 188 of the socket 180 can both be formed as a separate connecting part into which the pipes to be connected are to be inserted, and can be injected directly on the connecting region 110 of the pipe 120 and thus already prepared for assembly.

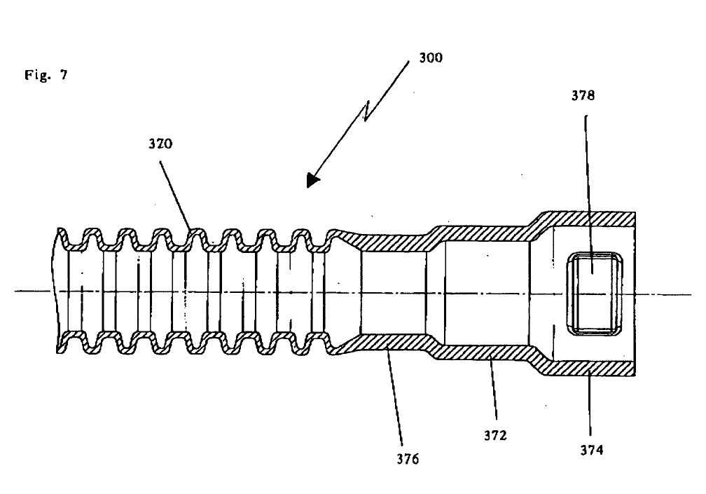

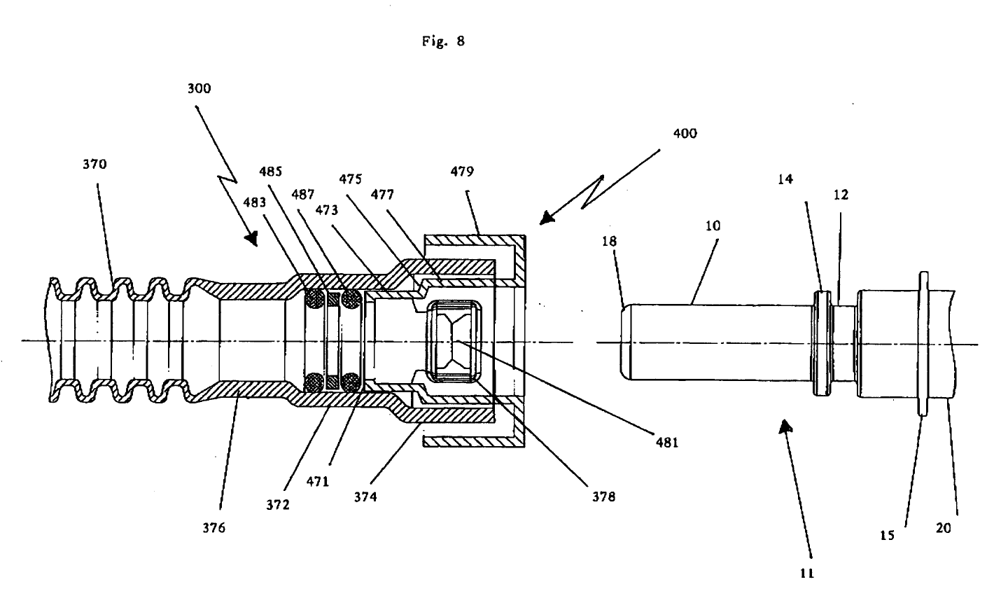

Identical or at least functionally identical means shown in FIGS. 7 to 11 are cited using corresponding reference numerals (483 corresponding to 583 corresponding to 683), wherein components of FIGS. 1 to 4 are cited using substantially the same reference numerals.

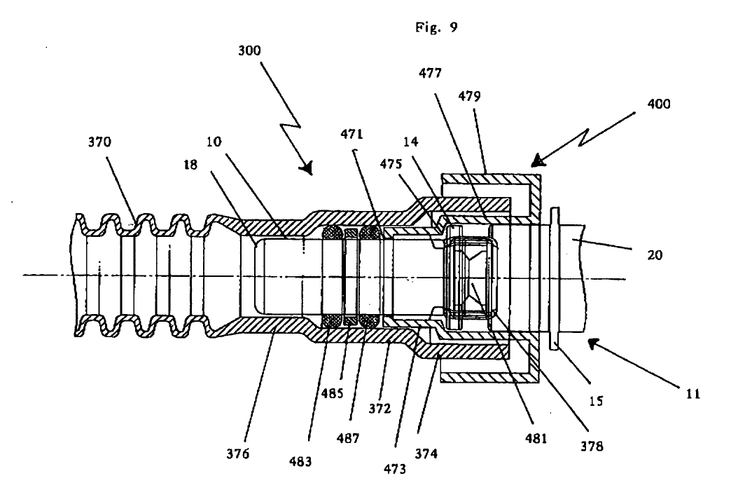

FIG. 7 shows a part of an embodiment of a plastic corrugated pipe connecting arrangement 300 in accordance with the invention. In accordance with the arrangement 300 shown, a corrugated pipe section 370 comprises a support section on at least one end, said support section comprising at least one region 372 having plain inner walls. In the embodiment shown in accordance with FIG. 7, another region 376 having plain inner walls is also provided between the corrugated pipe section 370 and the at least one region 372 having plain inner walls and a first diameter. At the end, facing away from the corrugated pipe section 370, of the region 372 having a first diameter, a second region 374 having a different diameter is provided. A locking section 378 is provided on said second diameter region 374. Said locking section 378 is arranged here as a bulge, but can also be formed as a recess. Said locking section 378 serves to be able to enter into holding engagement with a corresponding formation on a connector means (see FIGS. 8 and 9).

In FIGS. 8 and 9, identical or corresponding components are indicated by the same reference numerals as in FIG. 7. Describing them twice is therefore unnecessary. The support section 300 with the corrugated pipe section connected is fitted with two sealing means 483, 487 which are for example O-rings here, made for instance of rubber. The O-rings 483, 487 come to rest within the first diameter region 372 having at least plain inner walls. A distancing ring 485 is inserted between the O-rings 483, 487 and prevents the O-rings 483, 487 from directly contacting each other. This prevents the O-rings 483, 487 from being deformed in a non-defined way, if for instance an axially acting pressure or even a radially acting pressure acts on the O-rings. A connector means 400 comprises a correspondence section 481 which can be moved to a holding position with the locking section 37, in order to be able to fix the connector means onto the support section 300. It is possible here to realize both a latching connection and a screw connection, a catch connection or other types of connection.

The connector means 400 comprises a neck section 479 which surrounds and overlaps the support section over a partial outer circumference, wherein the correspondence section 481 is in this case advantageously provided on the inner circumference of the neck section 479, while the locking section is arranged on the outer circumference of the support section 300.

In the embodiment shown, the connector means 400 comprises two regions 477, 473 having different diameters, corresponding to the different diameters of the diameter regions 372, 374 of the support section 300. A collar section 475 which results between the diameter regions 473 and 477 of the connector means 400 serves as an abutting section for the radially protruding rib 14 of the plain region 10 of the corrugated pipe 20 to be connected. A pressing area 471 is formed on the end of the diameter region 473 of the connector means 400, wherein if necessary pressure can also be exerted on the sealing elements or O-rings 483, 487 via said pressing area 471, in order to improve a sealing and/or holding function of the components 483, 487.

FIG. 9 shows how the plain region 10 of the corrugated pipe 20 engages with the support region 300 of the corrugated pipe 370. The O-rings 483, 487 are then deformed uniformly (in the representation, the O-rings are—purely schematically—only shown deformed on one side). If the connector means 400 is fixed in the axial direction, for instance by being screwed down, a pressure can also be exerted on the O-rings in the axial direction by the pressing area 471. The corrugated pipe 11 with the plain region connected to it can then be particularly effectively fixed to the support section 300. The rib 14 and another rib 15 then serve to be able to set defined positions, visible from without or tactile through abutting, between the individual components of the arrangement in accordance with the invention.

It is recognizably an essential component of the invention to provide a way of providing abutting sections, which are advantageously plain-walled, on each of the inner region of the support section 300 and the outer region of the plain-walled section 10, between which the O-rings can be pressed and held, forming a seal. Furthermore, it is an essential element of the invention to provide a holding section, for instance in the form of the control section or correspondence section 481, 378, in order to be able to fix a connector means holding the corrugated pipe 20 to be connected together with the plain region 10.

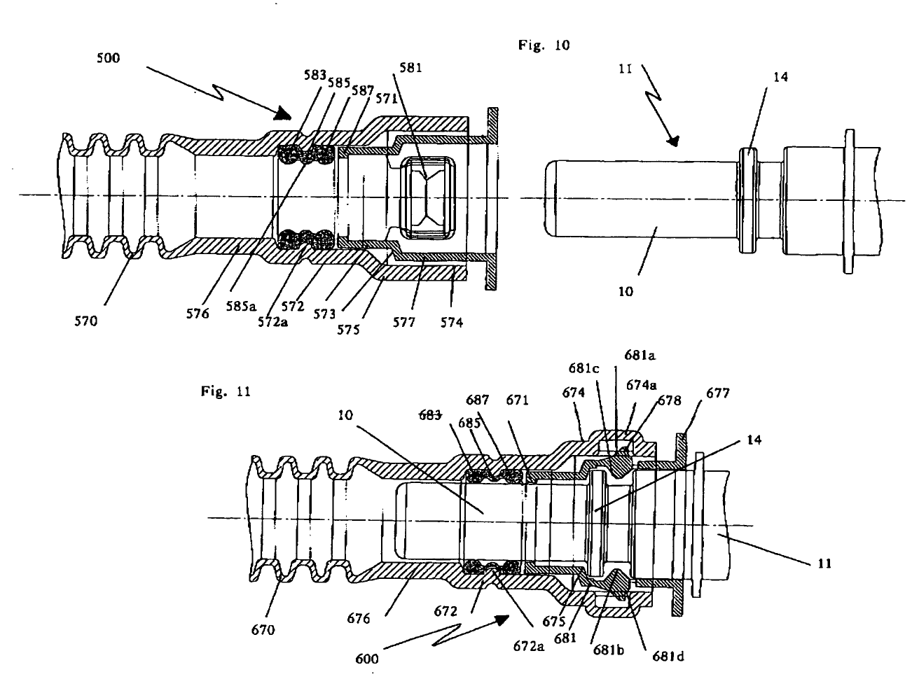

Components shown in FIG. 10 which have been explained in the course of describing previous embodiments shall not be additionally discussed. In FIG. 10, a connecting section 500 is integrally connected to a corrugated pipe 570. A support section having a first diameter is provided in said connecting section 500 and is formed with a holding function region 572a on its inner circumference. In the embodiment shown, this engagement function region 572a is formed as an extension directed radially inwards. It can of course be formed differently, for example as a groove extended radially outwards or the like, wherein a sealing and/or holding element 583, 585, 587 formed as one piece is then provided, which comprises a holding function region 585 which can hold the part 583, 585, 587 formed as one piece in its position within the support section and in particular within the first diameter region 572.

In the present case, a sealing function region 583, 587 is connected to the holding function region symmetrically on both sides in the axial direction. The holding function region can also be fitted with a sealing area 585a, in order to yield an additional sealing effect. It is, however, also possible to manage with just a sealing function region 583 or 587, or to have both or even more sealing function regions 583, 587 connect to the holding function region 585 on one side, i.e. asymmetrically, in the axial direction. The remaining components shown in FIG. 10 correspond substantially to the components of previously explained embodiments and in this respect do not need to be discussed any more.

FIG. 11 shows another embodiment of a plastic corrugated pipe connecting arrangement 600 in accordance with the invention, in a corrugated pipe section 670 which is formed as one piece and connected to a support section comprising a diameter region 672. In the embodiment shown here, a formation of the connector means can concretely be seen which is to be held with a locking section 678 in a correspondence section 674a of the support section 674 having a second diameter. The locking section 678 comprises an abutment protrusion 681d which can be brought into holding engagement with a wheel of the section 674a. The region of the connector means comprising the locking section 678 can then be formed with a conducting area 681a, such that the locking section 678 can yield radially inwards in the axial direction in which the connector means can be inserted into the support section, in order to then be able to spring back into the holding position in the correspondence section 674a, in order to be able to ensure that the connector means is reliably fixed. Opposite the locking section 678, the connector means can comprise a correspondence section 681 comprising an engagement section 681b which can engage behind the abutment section 14 of the corrugated pipe adapter region 10, 12, 14 which has been explained in more detail with reference to the previous FIGS. 1 to 6. The plain region 10, 12 and therefore the connecting region of the pipe 11, often referred to as the “maste r part”, can thus be reliably held within the support section via the connector means, wherein the sealing and/or holding element 683, 685, 687 can additionally provide sealing functions.

The embodiment 600 is formed reversibly, i.e. the connecting region 10 of the corrugated pipe 11 can be disassembled from the connecting arrangement without being destroyed, while the connection is otherwise not releasable. This is achieved by the fact that, when the corrugated pipe 11 is pulled, it experiences a tensile stress together with the connector means, such that the abutment protrusion 681d abuts the rim of the correspondence section 674a, such that the locking section 678 is radially blocked.

Consequently, the locking section 678 cannot yield outwards and the engagement section 681b remains in the engagement position and holds the pipe 11 fixed above the abutment section 14.

If a thrusting force acting in the direction of fixing the pipe is exerted on the connector means via a neck region 677, while the pipe 11 is pulled, the abutment protrusion 681d does not enter a blocking position on the correspondence section 674a and consequently can yield radially. Thus, when the rear side of the abutment section 14 of the pipe 11 pushes onto a guiding area 681c of the control section 678, the control section 678 is hung out radially outwards and the abutment section 14 and therefore the pipe 11 are disengaged and released.

A corrugated pipe connecting section 10, 14 can thus be securely held on the one hand, but also easily released on the other.

In the foregoing description, preferred embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A corrugated pipe connecting arrangement comprising a corrugated pipe with corrugations extended transverse to its longitudinal axis, which can be arranged at substantially identical distances from each other, wherein said corrugated pipe is formed with a one-piece plain region at at least one end, said plain region comprising an abutment section, and can engage with a connecting element which may be merged with said plain region and said abutment section.

2. The corrugated pipe connecting arrangement as set forth in claim 1, characterized in that the abutment section is formed at least over a partial circumference, preferably over a full circumference.

3. The corrugated pipe connecting arrangement as set forth in claim 1, characterized in that the abutment section is formed as a radially protruding rib, as a ring or the like.

4. The corrugated pipe connecting arrangement as set forth in claim 1, characterized in that the abutment section is formed such that the plain region comprises a constriction and beyond said constriction falls back to a diameter which is greater than that of the constriction, such that the abutment section is formed as a radially protruding rib, as a ring or the like.

5. The corrugated pipe connecting arrangement as set forth in claim 1, characterized in that a connecting section is arranged between the section comprising the corrugations and the abutment section.

6. The corrugated pipe connecting arrangement as set forth in claim 5, characterized in that the abutment section is even.

7. The corrugated pipe connecting arrangement as set forth in claim 1, characterized in that said connecting element comprises at least one sealing means, in particular an O-ring, which can engage with the plain region, forming a seal.

8. The corrugated pipe connecting arrangement as set forth in claim 1, characterized in that the connecting element comprises an abutting means which can be inserted into an accommodating space for the plain region, surrounding it.

9. The corrugated pipe connecting arrangement as set forth in claim 7, characterized in that the sealing element is accommodated between said abutting means and a collar region.

10. The corrugated pipe connecting arrangement as set forth in claim 8, characterized in that the abutting means comprises a radial extension which is extended outwards and can engage with a latching recess.

11. The corrugated pipe connecting arrangement as set forth in claim 1, characterized in that a closure element is provided on the connecting element which is extended radially inwards and can abut, preferably reversibly, against the abutment section via at least one recess in the connecting element.

12. The corrugated pipe connecting arrangement as set forth in claim 11, characterized in that said closure element can be formed for instance as a fork-like blocking member, as a pivoting and latching film hinge blocking element or the like.

13. The corrugated pipe connecting arrangement as set forth in claim 1, characterized in that the pipe wall is formed thicker in the region of the plain region then in the corrugated region.

14. The corrugated pipe connecting arrangement as set forth in claim 1, characterized in that the connecting element is formed, for instance injected, onto the end of the corrugated pipe.

15. A corrugated pipe comprising at least one corrugated pipe section and at least one end region, wherein said end region is formed as one piece with said corrugated pipe section as a plain region, wherein an abutment section is formed in the run of said plain region.

16. The corrugated pipe as set forth in claim 15, characterized in that the plain region comprises a thicker wall than the corrugated pipe section.

17. The corrugated pipe as set forth in claim 15, characterized in that the abutment section is formed at least over a partial circumference, preferably over a full circumference.

18. The corrugated pipe as set forth in claim 15, characterized in that the abutment section is formed as a radially protruding rib, as a ring or the like.

19. The corrugated pipe as set forth in claim 15, characterized in that a connecting section is arranged between the section comprising the corrugations and the abutment section.

20. The corrugated pipe as set forth in claim 15, characterized in that the closure section is even or plain.

21. A corrugated pipe connecting arrangement comprising a corrugated pipe with corrugations extended transverse to its longitudinal axis, wherein said corrugated pipe is provided on at least one of its end regions with a connecting region which is formed integrally with the corrugated pipe and can be inserted in a socket connecting section, said connecting region being provided, for connecting to said socket connecting section, with at least one, preferably a number of serrated tooth-like profiles which run in the insertion direction for connecting to the socket connecting section and can abut the inner circumference of the socket connecting section.

22. The corrugated pipe connecting arrangement as set forth in claim 21, characterized in that the inner circumference of the socket connecting section is plain-walled, at least in regions, over a full circumference.

23. The corrugated pipe connecting arrangement as set forth in claim 21, characterized in that said serrated tooth-like profile has an ascending flank in the insertion direction which is at an acute angle with respect to the insertion direction.

24. The corrugated pipe connecting arrangement as set forth in claim 21, characterized in that the serrated tooth-like profile exhibits a steeply flank on the side facing away from the insertion direction in the socket connecting section.

25. A corrugated pipe comprising at least one corrugated pipe section and at least one connecting region, wherein said connecting region is formed as one piece with said corrugated pipe section and the connecting region is provided with at least one, preferably more serrated tooth-like profiles running in the insertion direction, direction, for connecting to a connecting section.

26. The corrugated pipe as set forth in claim 25, characterized in that the serrated tooth-like profile (130) has an ascending flank in the insertion direction which is at an acute angle with respect to the insertion direction.

27. The corrugated pipe as set forth in claim 25, characterized in that the serrated tooth-like profile exhibits a steeply descending flank on the rear side of the ascending flank, said steeply descending flank causing a significant resistance counter to the insertion direction with respect to wrenching forces.

28. A plastic corrugated pipe connecting arrangement comprising a plastic corrugated pipe section with corrugations extended transverse to its longitudinal axis, comprising an integrally formed support section at at least one end, wherein said support section comprises a first diameter region, wherein at least one sealing and/or holding element can be inserted into said first diameter region, preferably axially held by a connector means.

29. The plastic corrugated pipe connecting arrangement as set forth in claim 28, characterized in that said connector means comprises a pressing area which can be placed onto one of said sealing and/or holding elements.

30. The plastic corrugated pipe connecting arrangement as set forth in claim 28, characterized in that the sealing and/or holding element is formed from a part, manufactured as one piece, which comprises a holding function region and at least one sealing function region.

31. The plastic corrugated pipe connecting arrangement as set forth in claim 30, characterized in that an engagement function region corresponding to said holding function section of the part manufactured as one piece is provided on the inner circumference of the first diameter region, said engagement function region holding the part manufactured as one piece in the axial direction.

32. The plastic corrugated pipe connecting arrangement as set forth in claim 30, characterized in that the part manufactured as one piece comprises two sealing function regions which are arranged symmetrically or asymmetrically with respect to the holding function region in the axial direction of the arrangement, wherein in particular the holding function section can additionally comprise a sealing area provided on the inner circumference.

33. The plastic corrugated pipe connecting arrangement as set forth in claim 28, characterized in that a number of sealing and/or holding elements are preferably provided with distancing ring(s) lying in between.

34. The plastic corrugated pipe connecting arrangement as set forth in claim 30, characterized in that at least one locking section is provided on the outer and/or inner circumference of the support section and points towards a locking position via a correspondence section of the connector means, wherein said locking section and the connector section produce a latching connection, a screw connection, a bayonet connection or the like.

35. The plastic corrugated pipe connecting arrangement as set forth in claim 31, characterized in that two locking bulges are provided opposite each other on the outer circumference of the support circumference, which can engage with assigned correspondence sections.

36. The plastic corrugated pipe connecting arrangement as set forth in claim 28, characterized in that the support section comprises a second and/or a third diameter region, wherein at least one is arranged in front of the first diameter region and at least one is arranged behind the first diameter region.

37. The plastic corrugated pipe connecting arrangement as set forth in claim 28, characterized in that the connector means comprises a neck, the correspondence section or sections being provided on the inner circumference of said neck.

38. The plastic corrugated pipe connecting arrangement as set forth in claim 28, characterized in that the connector means comprises a collar section on its inner circumference.

39. The plastic corrugated pipe connecting arrangement as set forth in claim 28, characterized in that a locking section comprises an abutment protrusion which secures said locking section against yielding radially under tensile stress.

40. The plastic corrugated pipe connecting arrangement as set forth in claim 28, characterized in that the locking section comprises a guiding area which faces the pipe to be held and deflects the locking section radially outwards when a tensile force is exerted on the pipe, wherein the pipe acts on said guiding area via an abutment section, in particular when a thrusting force is exerted on the connector means.

41. A plastic corrugated pipe comprising a plastic corrugated pipe section and a plastic corrugated pipe connecting arrangement as set forth in claim 1 at one end of said plastic corrugated pipe section and comprising a plastic corrugated pipe connecting arrangement as set forth in claim 28 at the other end of the plastic corrugated pipe section.
